(19) United States
(12) Patent Application Publication
(10) Pub. No.: US 2025/0358021 A1
(43) Pub. Date: Nov. 20, 2025

(54) SYSTEMS AND METHODS FOR CONTINUOUS SIGNAL GENERATION USING TRANSFORMATIONS

(71) Applicant: EMx Systems LLC, Austin, TX (US)

(72) Inventor: Benjamin Charles Shank, Austin, TX (US)

(73) Assignee: EMx Systems LLC, Austin, TX (US)

(21) Appl. No.: 19/209,787

(22) Filed: May 15, 2025

Related U.S. Application Data
(60) Provisional application No. 63/647,958, filed on May 15, 2024.

(51) Int. Cl. H04B 14/02; G06N 3/08

(52) U.S. Cl. CPC H04B 14/026; G06N 3/08

(57) ABSTRACT

The present invention provides systems and methods for reconstructing continuous physiological signals from non-invasive input signals using a modular framework combining fractional calculus, time-frequency transformations, and deep learning. Input signals acquired from sensors such as ECG, PPG, or SCG undergo preprocessing that includes normalization and computation of fractional derivatives to capture fine-grained temporal dynamics. A first neural network applies an adaptive, learnable time-frequency transformation—such as a complex Morse wavelet transform—to extract meaningful representations. These are then processed by a second neural network to reconstruct continuous signals, such as arterial blood pressure, in real time. The networks are trained using loss functions like mean squared error and dynamic time warping against reference signals. The system operates without requiring calibration and generalizes across populations and sensor conditions. This architecture enables accurate, calibration-free signal monitoring applicable to healthcare, industrial diagnostics, and beyond, offering a scalable solution for real-time signal reconstruction from multimodal, non-invasive biosensors.

### CROSS REFERENCE TO RELATED APPLICATIONS

This application claims priority to U.S. Provisional Patent Application No. 63/647,958, filed May 15, 2024, the entire contents of which are incorporated herein by reference.

### FIELD OF THE INVENTION

The present invention generally relates to signal processing and non-invasive monitoring systems. More specifically, it pertains to systems and methods for generating continuous signals from input signals using fractional calculus and machine learning techniques.

### BACKGROUND OF THE INVENTION

Continuous monitoring of certain parameters, such as arterial blood pressure (ABP) or glucose levels, traditionally requires invasive techniques, intermittent non-invasive methods and/or frequent calibrations. For example, invasive techniques such as arterial lines in healthcare settings, carry risks of infection, bleeding, and are unsuitable for long-term or ambulatory monitoring. Non-invasive techniques, such as cuff-based oscillometry or tonometry, offer safer alternatives but are limited to snapshot measurements, require periodic recalibration, and are prone to artifacts from body movement, arm position, and vascular conditions such as arterial stiffness.

In the field of physiological signal processing, multimodal sensor data fusion has shown promise. For example, ECGs tend to be macroscopic projections of ionic currents governed by nonlinear membrane dynamics, blood pressure regulation involves baroreceptor-mediated feedback and interactions with the autonomic nervous system. Combining signals such as electrocardiogram (ECG) and PPG (commonly used to estimate pulse transit time), or seismocardiography (SCG) and impedance cardiography (ICG), can provide richer information about cardiovascular dynamics.

However, such physiological systems are sensitive to initial conditions and exhibit chaotic behavior, making it difficult for current existing models to provide accurate reconstructions. Existing approaches often rely on hand-crafted features, fixed transformations, or shallow regression models that struggle to capture the complex, nonlinear dynamics present in biosignal generation and regulation. Moreover, they may need per-user calibration, fail to generalize across populations, or cannot adapt to changes in sensor conditions.

While deep learning approaches have been proposed, such as 1D convolutional neural networks (CNNs) or U-Net architectures, they typically treat the input signals as 1D time series and overlook the importance of intermediate signal representations, such as multiscale time-frequency content or fractional-order dynamics. Moreover, many models lack architectural modularity and do not separate information extraction from transformation and reconstruction processes. This limits their ability to generalize across subjects or operate robustly in the presence of signal variability and noise.

Techniques such as fractional derivatives, which are useful for characterizing dynamics between integer-order derivatives and adaptive time-frequency representations, remain underutilized in signal monitoring applications. There remains an unmet need for a robust, calibration-free, and generalizable system that can reconstruct continuous signals from multimodal non-invasive sensor inputs.

In summary, there is a need for an improved system that can reconstruct continuous signals from multiple non-invasive sensors without requiring external calibration. Such a system should handle multimodal inputs, automatically extract informative features (potentially across multiple derivative orders and time-frequency scales), and produce accurate continuous outputs in real time. It should overcome the limitations of prior art by leveraging modern machine learning (e.g., deep neural networks) while ensuring interpretability and adaptability through techniques like fractional-order feature extraction and adaptive time-frequency representation.

The present invention addresses these challenges by integrating fractional calculus, transformations, and modular deep learning architectures into a novel, end-to-end framework for signal reconstruction. This framework enables accurate signal synthesis from indirect inputs, supports generalization without external calibration, and offers a scalable architecture for diverse applications.

### SUMMARY OF THE INVENTION

The present invention provides systems, methods, and computer program products for reconstructing at least one continuous signal from at least one input signal. The invention overcomes limitations of prior art by leveraging advanced signal processing and machine learning to deliver real-time, accurate, and calibration-free continuous signals.

In one aspect of the invention, a system includes at least one of the functional modules that process at least one input signal to reconstruct at least one continuous signal. These modules work to transform raw sensor signals into the desired continuous signal.

Signal Preprocessing Module: In this module, conditioning and feature extraction is performed on the at least one signal. The signals are passed through a derivative operator that computes at least one fractional derivative to generate at least one output representation.

First Transformation Module: In this module, at least one first time-frequency transformation is applied to the at least one output representation to generate at least one time-frequency representation. The module includes at least one neural network. At least one parameter of the at least one first time-frequency transformation is a learnable parameter.

Second Neural Network Module: In this module, at least one second neural network transforms the at least one time-frequency representation to reconstruct at least one continuous signal.

Training Module: In this module, at least one training module is configured to optimize at least one of the at least one first neural network and the at least one second neural network by using at least one loss function comparing the at least one reconstructed signal to at least one reference signal.

In another aspect of the invention, a method includes at least one of the functional steps that generate at least one continuous signal from at least one input signal. These steps work to transform raw sensor signals into the desired continuous signal.

Signal Preprocessing Step: In this step, conditioning and feature extraction is performed on the at least one signal. The signals are passed through a derivative operator that computes at least one fractional derivative to generate at least one output representation.

First Transformation Step: In this step, at least one first time-frequency transformation is applied to the at least one output representation to generate at least one time-frequency representation. The module includes at least one neural network. At least one parameter of the at least one first time-frequency transformation is a learnable parameter.

Second Neural Network Step: In this step, at least one second neural network transforms the at least one time-frequency representation to reconstruct at least one continuous signal.

Training Step: In this step, at least one training module optimizes at least one of the at least one first neural network and the at least one second neural network by using at least one loss function comparing the at least one reconstructed signal to at least one reference signal.

In still another aspect of the invention, a non-transitory computer-readable medium stores instructions that, when executed by at least one processor, cause the processor to perform at least one of the functional steps that generate at least one continuous signal from at least one input signal. These steps work to transform raw sensor signals into the desired continuous signal.

Signal Preprocessing Step: In this step, conditioning and feature extraction is performed on the at least one signal. The signals are passed through a derivative operator that computes at least one fractional derivative to generate at least one output representation.

First Transformation Step: In this step, at least one first time-frequency transformation is applied to the at least one output representation to generate at least one time-frequency representation. The module includes at least one neural network. At least one parameter of the at least one first time-frequency transformation is a learnable parameter.

Second Neural Network Step: In this step, at least one second neural network transforms the at least one time-frequency representation to reconstruct at least one continuous signal.

Training Step: In this step, at least one training module optimizes at least one of the at least one first neural network and the at least one second neural network by using at least one loss function comparing the at least one reconstructed signal to at least one reference signal.

Key features of the invention include at least one of the following advantages:

Koopman Operator Approximation: The systems and methods can approximate a Koopman operator by modeling the hidden nonlinear dynamics of signals through a learned intermediate feature space. A Koopman operator models hidden nonlinear dynamics of processes as pseudostationary bandlimited signals. This enables the systems and methods to capture complex, nonlinear relationships between input signals and the target signal, allowing a linear model to represent complex nonlinear evolution thereby enhancing reconstruction accuracy.

Non-Invasive Continuous Monitoring: The systems and methods provide real-time physiological signals without invasive methods, suitable for critical care, emergency medical services (EMS), or non-clinical settings.

Calibration-Free Operation: The systems and methods are trained end-to-end to infer absolute signal values, eliminating the need for per-user calibration or external devices.

Robust and Modular Architecture: Each component of the systems and methods is modular and independently tunable, supporting architectural transparency, interpretability, and integration of additional modalities. Additionally, fractional derivatives and adaptive transformations enhance accuracy by capturing subtle dynamics across diverse signals.

Broad Applicability: The architecture of the systems and methods is generalizable to extend to applications, including but not limited to blood pressure monitoring, continuous glucose monitoring (e.g., via skin impedance and acoustic data), industrial diagnostics (e.g., reconstructing pressure waveforms in pipelines using external magnetic sensors like magnetohydrodynamic sensors), and automotive predictive maintenance (e.g., estimating engine torque from engine sensor data).

AI Training Capabilities: The systems and methods support model training, which supports supervised, self-supervised, and federated learning paradigms. The architecture enables personalization via on-device fine-tuning and protects privacy through decentralized gradient sharing.

### BRIEF DESCRIPTION OF THE DRAWINGS

FIG. 1 is a block diagram of an exemplary system architecture.

### DETAILED DESCRIPTION OF THE INVENTION

Embodiments of the present invention will now be described in detail, with references to the accompanying drawings where applicable. It is to be understood that the drawings and examples are provided to illustrate the concepts of the invention and should not be construed as limiting. Wherever possible, like reference numbers indicate like elements or steps in the drawings. The invention may be embodied in many different forms and should not be construed as limited to the specific embodiments set forth herein; rather, these embodiments are provided so that this disclosure will be thorough and enabling to those skilled in the art.

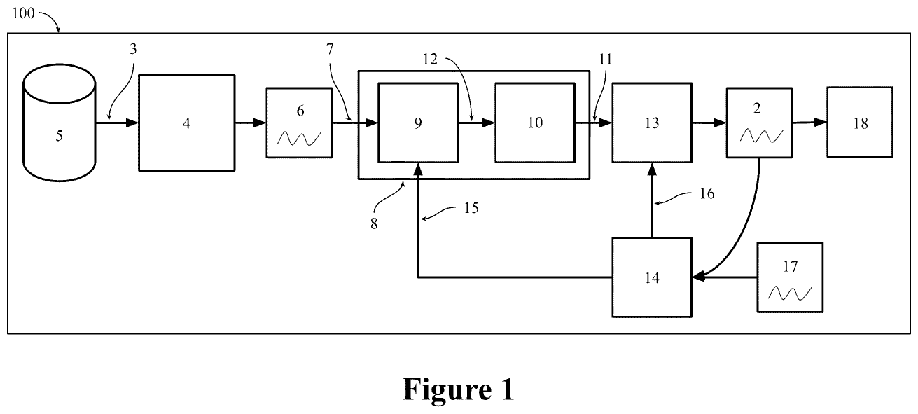

### Referencing FIG. 1, System Overview and Components

An embodiment of the invention includes a system (100) may include at least one data source (5), at least one signal preprocessing module (4), at least one transformation module (8), at least one second neural network (13), and at least one training module (14).

In an embodiment of the invention, the system (100) generates at least one continuous signal (2) from at least one input signal (3).

In an embodiment of the invention, the at least one signal preprocessing module (4) is configured to receive at least one input signal (3).

In an embodiment of the invention, the at least one signal preprocessing module (4) is configured to compute at least one fractional derivative (6).

In an embodiment of the invention, the at least one signal preprocessing module (4) is configured to generate at least one output representation (7).

In an embodiment of the invention, the at least one transformation module (8) is configured to apply at least one first time-frequency transformation (10) to the at least one output representation (7).

In an embodiment of the invention, the at least one first time-frequency transformation (10) is applied to the at least one output representation (7).

In an embodiment of the invention, the at least one transformation module (8) generates at least one time-frequency representation (11).

In an embodiment of the invention, the at least one transformation module (8) includes at least one first neural network (9).

In an embodiment of the invention, at least one parameter of the at least one first time-frequency transformation (10) is a learnable parameter (12).

In an embodiment of the invention, the at least one second neural network (13) transforms the at least one time-frequency representation (11).

In an embodiment of the invention, the at least one second neural network (13) reconstructs at least one continuous signal (2).

In an embodiment of the invention, the at least one training module (14) is configured to optimize at least one neural network.

In an embodiment of the invention, the at least one training module (14) is configured to optimize (15) the at least one first neural network (9).

In an embodiment of the invention, the at least one training module (14) is configured to optimize (16) the at least one second neural network (13).

In an embodiment of the invention, the at least one training module (14) optimizes at least one neural network by using at least one loss function.

In an embodiment of the invention, the at least one training module (14) uses at least one loss function by comparing the at least one reconstructed signal (2) to at least one reference signal (17).

An embodiment of the invention may include a method for generating at least one continuous signal from at least one input signal.

An embodiment of the invention may include the method receiving at least at least one input signal.

An embodiment of the invention may include the method computing at least one fractional derivative.

An embodiment of the invention may include the method generating at least one output representation.

An embodiment of the invention may include the method applying at least one first time-frequency transformation.

An embodiment of the invention may include the method applying at least one first time-frequency transformation to the at least one output representation.

An embodiment of the invention may include the method generating at least one time-frequency representation.

An embodiment of the invention may include the method, wherein at least one parameter of the at least one first time-frequency transformation is a learnable parameter.

An embodiment of the invention may include the method using at least one first neural network.

An embodiment of the invention may include the method transforming the at least one time-frequency representation.

An embodiment of the invention may include the method reconstructing at least one continuous signal.

An embodiment of the invention may include the method using at least one second neural network.

An embodiment of the invention may include the method optimizing at least one neural network.

An embodiment of the invention may include the method optimizing the at least one first neural network.

An embodiment of the invention may include the method optimizing the at least the at least one second neural network.

An embodiment of the invention may include the method optimizing using at least one loss function.

An embodiment of the invention may include the method uses the at least one loss function comparing the at least one reconstructed signal to at least one reference signal.

### Input Signal Acquisition

In one embodiment of the invention, at least one input signal 3 is acquired from at least one non-invasive sensor 5, such as electrocardiogram (ECG), photoplethysmogram (PPG), seismocardiogram (SCG), or impedance cardiography (ICG) sensors. These signals may be collected individually or in combination, and represent physiological time-series data from various modalities.

### Signal Preprocessing Module

In one embodiment of the invention, at least one signal preprocessing module 4 receives the at least one input signal and performs preprocessing such as denoising, normalization, and temporal alignment. In a preferred embodiment, normalization occurs prior to further transformation.

In one embodiment of the invention, the system computes at least one fractional derivative 6 of each input signal. Fractional derivatives may span from zeroth to second order and may be computed via discrete spectral techniques, including operations in the Fourier domain. This process captures intermediate dynamics between conventional integer-order derivatives and emphasizes subtle transitions in signal morphology. The output of this step is at least one output representation 7, which may be structured as a high-dimensional tensor.

### Transformation Module and First Neural Network

In one embodiment of the invention, at least one transformation module 8 applies at least one first time-frequency transformation 10 to the output representation 7 to produce at least one time-frequency representation 11. This transformation enhances the representation of signal dynamics across multiple time and frequency scales.

In one embodiment of the invention, the time-frequency transformation is a complex Morse wavelet transform, with learnable parameters including beta, gamma, and wavelet order. Other suitable transformations may include continuous wavelet transforms, short-time Fourier transforms, or generalized S-transform variations, depending on application-specific constraints.

This transformation is implemented using at least one first neural network 9, which learns to adapt parameters of the transformation during training. At least one parameter of the time-frequency transformation is a learnable parameter 12, allowing the system to tailor feature extraction to the structure of physiological signals.

The resulting time-frequency representation may be structured as a tensor with dimensions corresponding to time, scale, and transformation kernel parameters.

### Signal Reconstruction via Second Neural Network

In one embodiment of the invention, the second neural network 13 receives the time-frequency representation 11 and performs a transformation, either linear, nonlinear, or both, to reconstruct at least one continuous signal 2. The second neural network may be implemented using architectures such as deep residual networks (ResNets), transformer encoders, U-Nets, or other context-aware sequence models capable of handling high-dimensional inputs and outputting smooth, continuous physiological signals.

### Training Module

In one embodiment of the invention, the training module 14 optimizes the neural networks using labeled datasets. The module can optimize the first neural network 9 and/or the second neural network 13 by minimizing a loss function that compares the reconstructed signal 2 to a reference signal 17.

In preferred embodiments, the loss function includes at least one of the following: Mean squared error (MSE)—emphasizing global waveform fidelity; Dynamic time warping (DTW) error—accounting for local time alignment discrepancies between predicted and reference waveforms.

Training can be conducted offline using population-level datasets. The architecture also supports self-supervised and federated learning paradigms for personalization and privacy-preserving model updates.

### Optional User Interface

In some embodiments, a user interface 18 may be provided to display the reconstructed continuous signal in real time or near real time. The interface may be graphical or data-driven, and support integration with medical decision support systems, monitoring dashboards, or export for downstream analytics.

### Features and Advantages

The system may be operated in a calibration-free mode, meaning it does not require per-user adjustments or comparison to invasive signals during live operation.

Further, the architecture supports:
Generalization across populations, sensor types, and signal conditions;
Modular deployment where components (e.g., preprocessing, transformation, reconstruction) can be independently tuned or swapped;
Broad applicability to physiological monitoring (blood pressure, glucose, respiration), industrial diagnostics (e.g., pipeline pressure estimation), and automotive sensor fusion (e.g., estimating torque or vibration states).

1. A system for generating at least one continuous signal from at least one input signal, the system comprising:
at least one signal preprocessing module configured to receive at least one input signal and compute at least one fractional derivative to generate at least one output representation;
at least one transformation module configured to apply at least one first time-frequency transformation to the at least one output representation to generate at least one time-frequency representation, wherein:
the at least one transformation module comprises at least one first neural network, and
at least one parameter of the at least one first time-frequency transformation is a learnable parameter;
at least one second neural network that transforms the at least one time-frequency representation to reconstruct at least one continuous signal; and
at least one training module configured to optimize at least one of the at least one first neural network and the at least one second neural network by using at least one loss function comparing the at least one reconstructed signal to at least one reference signal.

2. The system of claim 1, wherein the at least one input signal is acquired by at least one non-invasive sensor.

3. The system of claim 1, wherein the transformation by the at least one second neural network comprises at least one of a linear transformation or non-linear transformation.

4. The system of claim 1, wherein the at least one fractional derivative is computed between zeroth and second order.

5. The system of claim 1, wherein the at least one fractional derivative is assembled into at least one high-dimensional tensor.

6. The system of claim 1, wherein the at least one first time-frequency transformation comprises a complex Morse wavelet transform with learnable parameters including beta, gamma, and order.

7. The system of claim 1, wherein the at least one loss function comprises at least one of mean squared error and dynamic time warping error.

8. The system of claim 1, wherein the system is configured to operate without calibration using an external device.

9. The system of claim 1, wherein the at least one input signal is normalized prior to computing the at least one fractional derivative.

10. The system of claim 1, further comprising a user interface (18) to output the at least one reconstructed signal.

11. The system of claim 1, wherein the at least one fractional derivative is computed using Fourier domain operations.

12. The system of claim 1, wherein the optimization by the at least one training module uses offline training on datasets.

13. The system of claim 1, wherein the at least one time-frequency representation comprises a tensor with dimensions corresponding to time, scale, and kernel parameters.

14. A method for generating at least one continuous signal from at least one input signal, the method comprising:
receiving at least at least one input signal;
computing at least one fractional derivative to generate at least one output representation;
applying, using at least one first neural network, at least one first time-frequency transformation to the at least one output representation to generate at least one time-frequency representation, wherein at least one parameter of the at least one first time-frequency transformation is a learnable parameter;
transforming using at least one second neural network the at least one time-frequency representation to reconstruct at least one continuous signal; and
optimizing at least one of the at least one first neural network and the at least one second neural network by using at least one loss function comparing the at least one reconstructed signal to at least one reference signal.

15. A non-transitory computer-readable medium storing instructions that, when executed by at least one processor, causes the processor to:
receive at least at least one input signal;
compute at least one fractional derivative to generate at least one output representation;
apply, using at least one first neural network, at least one first time-frequency transformation to the at least one output representation to generate at least one time-frequency representation, wherein at least one parameter of the at least one first time-frequency transformation is a learnable parameter;
transform using at least one second neural network the at least one time-frequency representation to reconstruct at least one continuous signal; and
optimize at least one of the at least one first neural network and the at least one second neural network by using at least one loss function comparing the at least one reconstructed signal to at least one reference signal.
